(19) United States
(12) Patent Application Publication
(10) Pub. No.: US 2009/0293133 A1
(43) Pub. Date: Nov. 26, 2009

(54) Card Authorization Terminal System and a Card Management Method Using the Same

(76) Inventor: Jung-Hyung Suh, Seoul (KR)

Correspondence Address: SCHWEGMAN, LUNDBERG & WOESSNER, P.A., P.O. BOX 2938, MINNEAPOLIS, MN, 55402, US

(21) Appl. No.: 12/084,088

(22) PCT Filed: Oct. 30, 2007
(86) PCT No.: PCT/KR2007/005362

§ 371 Date: Apr. 24, 2008

(30) Foreign Application Priority Data
Nov. 1, 2006 (KR) 10-2006-0107252

(51) Int. Cl. H04L 9/32; H04N 7/16

(52) U.S. Cl. 726/28

(57) ABSTRACT

The present invention relates to a card authorization terminal system and an electronic card processing method using the card authorization terminal system. An authorization terminal system includes an exclusive database management system to update and delete property change information, and a card processing method uses the authorization terminal system. In the card processing method, since a physical memory area is efficiently managed, a problem of memory capacity limitation is solved, a processing speed delay caused by a file processing structure is improved, and various pieces of information may be managed.

### TECHNICAL FIELD

The present invention relates to an authorization terminal system and a card management method using the authorization terminal system, and more particularly, to an authorization terminal system using a data base management system and a card management method using the authorization terminal system.

### BACKGROUND ART

Recently, electronic cards, including a prepaid card or a post-payment card, are widely used to pay the cost of using various forms of transportation, including a bus or subway. In a post-payment card method, a transportation card function is added to a credit card and transportation fares incurred by a user are charged monthly with the credit card bill. In a prepaid card method, money is previously charged onto the prepaid card. In addition to a transportation payment method, the prepaid card has been highly used for various other payment methods.

A card authorization terminal system authenticates the transportation cards and charges corresponding fares. Recently, fares are differentiated according to property information (e.g., adult, and youth) and are charged.

To differently charge fares according to the property information, the card authorization terminal system is required to continuously manage changes of properties corresponding to a card number or an identification number (e.g., a change from a youth to an adult, or a discount rate change).

Conventional methods of the card authorization terminal system include a black list method in which erroneous card information is managed to be used when card authentication is performed, and a flag method (a bitmap method) in which change flags (bits) for entire cards are managed and used when the card authentication is performed. However, since change information is stored as a file type in a memory of an authentication system and is read to use when it is required in both methods, the following problems occur.

1. Limitation of Capacity and Processing Speed

In an operation process of a conventional card authentication system, since a physical memory area of a card terminal system is used, capacity may be limited and a processing speed may be delayed.

In further detail, in a conventional processing method, it takes a long time to read files stored in the memory and find a predetermined location. In addition, various types of information are required to be stored as the functions of the card become diversified, but four types of information are managed in the conventional processing method when two bits are used for one card since the conventional processing method (a bitmap method) has a cardinality limitation. That is, because of the structural limitation of the conventional bitmap method, one type of information occupies a large storage area, which harmfully affects memory capacity and data speed.

2. An operation of a card authorization terminal system may be harmfully affected due to complication and malfunction of a change management method.

In a conventional management method, according to conditions of an authorization terminal system, information may be disagreed or a load for managing additional information may occur when change information is frequently received to manage the change information and the change information is combined and managed according to a predetermined processing method. In addition, an erroneous operation may be performed since data are lost or unexpected letters are inserted when a main management system transmits data to a card authorization terminal device, or serious memory increase may occur when corresponding files are processed. In this case, the conventional card authorization terminal system uses the same process to perform authorization and change information search, and therefore the entire functions may have errors when some functions have errors.

### DISCLOSURE

### Technical Problem

### Technical Object

The present invention has been made in an effort to provide a card authorization terminal system for preventing malfunctions of a system and a card management method using the card authorization terminal system.

### Technical Solution

According to an exemplary embodiment of the present invention, a card authorization terminal system includes a card identifying unit, a database management unit, and an authorization processing unit. The card identifying unit deciphers card property information stored in a card and determines whether the card is valid. The database management unit generates final card property information based on the card property information deciphered by the card identifying unit and property change information stored in the database management unit. The authorization processing unit calculates charges and processing card transactions based on the final card property information generated by the database management unit.

In this case, the database management unit is realized as a database management system (DBMS) using an exclusive process that is different from those of the authorization processing unit and the card identifying unit.

In addition, the master property change information database includes a plurality of tables matched to card provider identification numbers, and each table stores card serial numbers and card property change information.

According to an exemplary embodiment of the present invention, in a card management method of a card authorization terminal system including a database management unit storing property change information, a) card property information written in a card is deciphered, b) property change information stored in the database management unit is searched based on the card property information deciphered from the card, and final card property information is generated, and c) charges are calculated by using the final card property information, and processing a card transaction list.

In b), the stored property change information is generated as the final card property information when the database management unit stores the property change information, and the card property information deciphered in a) is generated as the final card property information when the database management unit does not store the property change information.

### ADVANTAGEOUS EFFECTS

According to the exemplary embodiment of the present invention, since a physical memory area is efficiently managed, a problem of memory capacity limitation is solved, and a processing speed delay caused by a file processing structure or multiple processes is improved.

In addition, since an exclusive database management system is used to perform an exclusive processing logic, malfunctions of some units may not affect other units.

Since the amount limitation of change management information is solved and various types of card information may be managed, various services using a card may be provided.

### DESCRIPTION OF DRAWINGS

FIG. 1 is a diagram of a transportation card management system according to an exemplary embodiment of the present invention.

FIG. 2 is a block diagram of an internal configuration of a card authorization terminal system according to the exemplary embodiment of the present invention.

FIG. 3 is a diagram of a database management unit according to the exemplary embodiment of the present invention.

FIG. 4 is a flowchart representing a card management method according to the exemplary embodiment of the present invention.

FIG. 5 is a diagram representing a method for receiving property change information according to the exemplary embodiment of the present invention.

FIG. 6 is a flowchart representing a method for processing final card property information in the database management unit according to the exemplary embodiment of the present invention.

FIG. 7 is a diagram of a process for updating property information in a database management system according to the exemplary embodiment of the present invention.

### BEST MODEL

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” and “comprising”, will be understood to imply the inclusion of stated elements but not the exclusion of any other elements.

A card authorization terminal system 100 according to an exemplary embodiment of the present invention and a card management method using the card authorization terminal system 100 will now be described with reference to the figures.

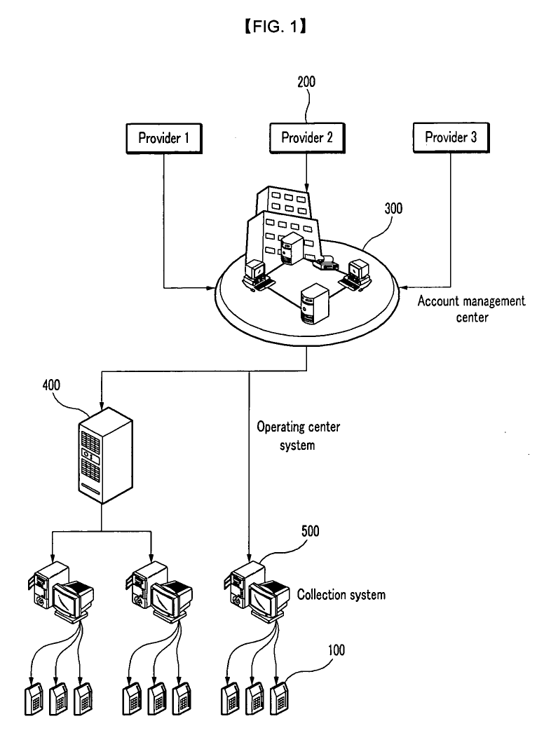

FIG. 1 is a diagram of a transportation card management system according to the exemplary embodiment of the present invention.

A card provider system 200 issues a card including card property information (e.g., card serial numbers, a valid date, a card type, a provider identification number, usage information, and discount information), and stores the card property information in a database (not shown) of the card provider system 200. In addition, when the card property information is changed according to a user's request or a policy of a card provider, the changed information is stored in a database, and card property change information is cyclically transmitted to an account management center system 300.

The account management center system 300 combines the property change information received from the card provider system 200 for every predetermined cycle or when a lower system transmits a request, and transmits the combined property change information to the card authorization terminal system 100 through an operating center system 400 or a collection system 500.

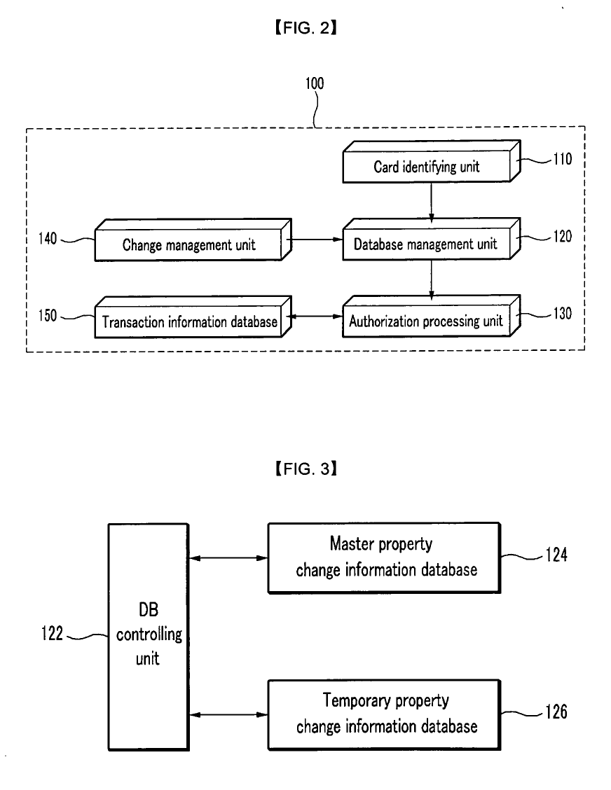

FIG. 2 is a block diagram of an internal configuration of the card authorization terminal system 100 according to the exemplary embodiment of the present invention.

As shown in FIG. 2, the card authorization terminal system 100 according to the exemplary embodiment of the present invention includes a card identifying unit 110, a database management unit 120, an authorization processing unit 130, a change management unit 140, and a transaction information database 150.

The card identifying unit 110 reads the card property information (e.g., the card serial numbers, the valid date, the card type, the provider identification number, the usage information, and the discount information) that is included when a card is issued, and determines whether the card is valid.

The change management unit 140 cyclically receives the property change information including change information of card properties from the operating center system 400 or the collection system 500, and transmits the received information to the database management unit 120. Here, the property change information includes user information (allowance or non-allowance) and discount information (adult or youth).

The database management unit 120 manages the card property information received from the card identifying unit 110 and the property change information received from the change management unit 140 and cyclically updated, and generates final card property information required to perform an authorization process based on the card property information and the property change information.

The authorization processing unit 130 uses the final card property information output from the database management unit 120 to calculate charges and perform the authorization process, and stores an authorization process result in the transaction information database 150.

In this case, the database management unit 120 according to the exemplary embodiment of the present invention uses an exclusive database management system (DBMS) using a process that is different from the card identifying unit 110 and the authorization processing unit 130, to efficiently manage information input and output to/from the card authorization terminal system 100.

The DBMS is exclusive software such as Oracle or MS SQL that may easily and quickly add/modify/delete various data. In the exemplary embodiment of the present invention, a small DBMS that may be provided in a terminal authorization system is used as a program used by a plurality of computer users to write data in a database or have access to the data.

The DBMS combines data separated in each application software, the combined data are then shared by each application software, and therefore information may be systematically used. In this case, the DBMS may perform \textcircled{1} definition of data structure, \textcircled{2} accumulation of data according to the data structure, \textcircled{3} search and update of data by database languages, \textcircled{4} execution control of concurrent data processes of a plurality of users, \textcircled{5} return to a previous state when an abnormal updating phenomenon occurs, and \textcircled{6} security of information.

Since the database management unit 120 according to the exemplary embodiment of the present invention is realized as the DBMS that is an exclusive process, large capacity data may be quickly traced in a small space. In addition, since an additional process that is different from an authorization process, a malfunction of the corresponding unit does not affect other functions, and therefore a problem of the entire error of a terminal system that is caused by the malfunction may be structurally prevented.

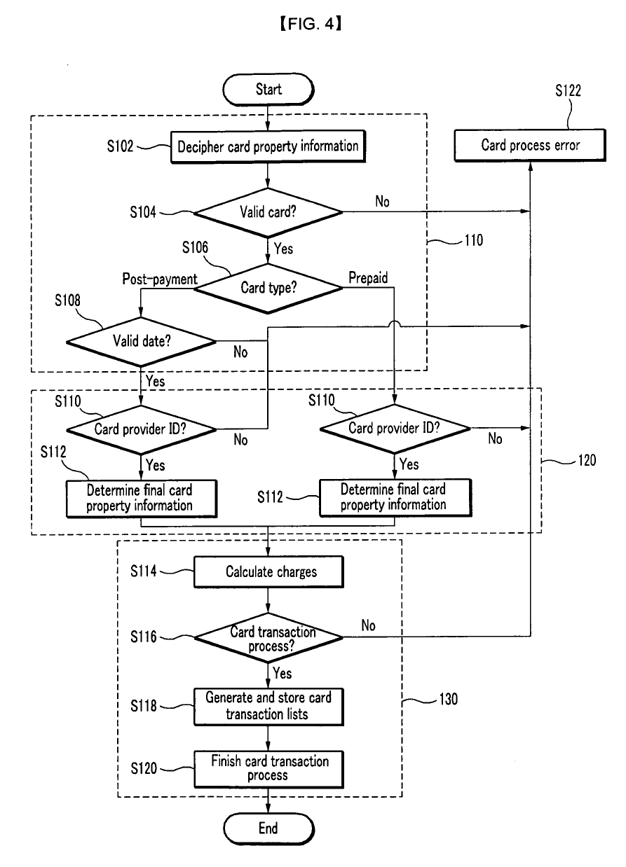

FIG. 3 is a diagram of the database management unit 120 according to the exemplary embodiment of the present invention.

As shown in FIG. 3, the database management unit 120 according to the exemplary embodiment of the present invention includes a database controlling unit 122, a master property change information database 124, and a temporary property change information database 126.

The master property change information database 124 stores changed card property information. In this case, the master property change information database 124 includes a plurality of tables matched to card provider identification numbers, and each table stores card serial numbers and property information of a corresponding card provider.

The temporary property change information database 126 temporarily stores property change information received from the change management unit 140.

The database controlling unit 122 stores the new property change information received from the change management unit 140 in the temporary property change information database 126, and cyclically updates the master property change information database 124 based on the new property change information stored in the temporary property change information database 126. In this case, when the master property change information database 124 is updated based on the new property change information, the database controlling unit 122 deletes the property change information stored in the temporary property change information database 126.

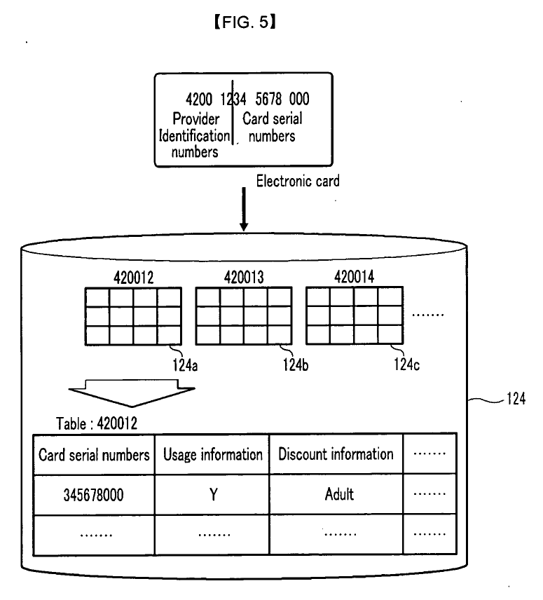

A card management method using the card authorization terminal system 100 according to the exemplary embodiment of the present invention will now be described with reference to FIG. 4.

FIG. 4 is a flowchart representing the card management method according to the exemplary embodiment of the present invention.

The card identifying unit 110 of the card authorization terminal system 100 deciphers the card property information (e.g., card serial numbers, a valid date, a card type, a card provider identification number, usage information, and discount information) stored in a memory of a card that contacts to or does not contact to the card identifying unit 110 in step S102.

Subsequently, the card identifying unit 110 determines in step S104 whether the corresponding card is valid, based on the card property information in step S102.

When it is determined in step S104 that the card is valid, the card identifying unit 110 identifies a card type to determine whether the card is a prepaid card or a post-payment card in step S106, and identifies a valid date from the card property information deciphered in step S102 to determine in step S108 whether the valid date is expired.

When it is determined in step S102 or S108 that the card is not valid or the valid date is expired, the card identifying unit 110 performs an error process for the corresponding card in step S222.

When it is determined in step S106 or S108 that the card is the pre-paid card or the valid date is not expired, the database controlling unit 122 of the database management unit 120 determines in step S110 whether the master property change information database 124 includes a table corresponding to the card provider identification number included in the card property information.

When it is determined in step S110 that there is the table corresponding to the card provider identification number, the database controlling unit 122 generates final card property information required to perform an authorization process based on the card property information obtained from the card and the property change information stored in the master property change information database 124 in step S112. When it is determined in step S110 that there is no provider identification number, the database controlling unit 122 performs an error process for the corresponding card in step S122.

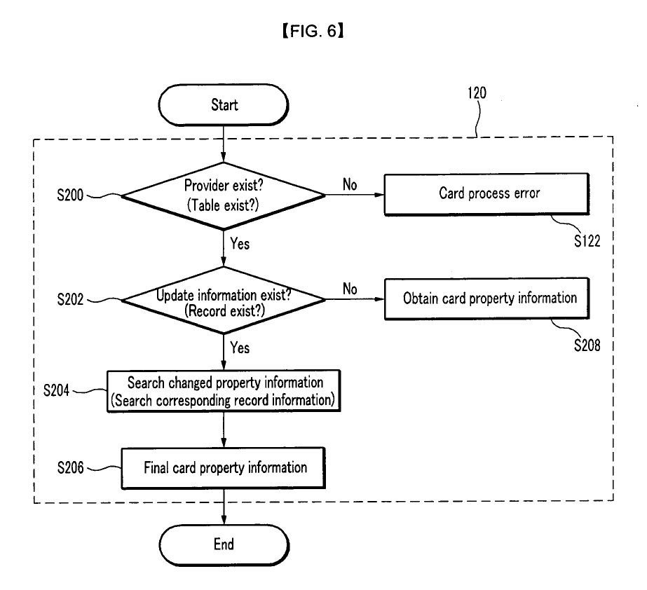

The steps S110 and S112 will be described later with reference to FIG. 6 in further detail.

The authorization processing unit 130 calculates charges based on user information or discount information stored in the final card property information received from the database management unit 120 in step S114, and identifies the charges calculated in step S114 and balance information stored in the card to determine in step S116 whether a card transaction process is performed.

When it is determined in step S116 that the card transaction process may be performed, the authorization processing unit 130 generates card transaction lists, stores them, and finishes a card authorization process in steps S118 and S120. When an error in the card transaction process occurs in step S116, the authorization processing unit 130 performs the error process for the corresponding card in step S200.

A method for managing the card property information in the database management unit 120 according to the exemplary embodiment of the present invention will be described with reference to FIG. 5.

The database management unit 120 according to the exemplary embodiment of the present invention performs generation, update, and search of the card property change information transmitted from the change management unit 140 and frequently changed. In addition, the database management unit 120 generates the final card property information based on the card property information output from the card identifying unit 110 and internally stored property change information.

In this case, according to the exemplary embodiment of the present invention, since the database management unit 120 is realized as a database management system using an additional process to perform the management process, a malfunction of the corresponding unit does not affect card identification, authorization process, and authentication functions, and therefore the number of errors is reduced.

As shown in FIG. 5, the database controlling unit 122 of the database management unit 120 according to the exemplary embodiment of the present invention generates a plurality of tables 124a, 124b, and 124c matched to provider identification numbers for identifying providers of card numbers stored in the master property change information database 124, and stores property information and card serial numbers corresponding to the provider identification numbers in the respective tables. In this case, when names of the respective tables are set to be equal to the provider identification numbers, searching speed may be improved and provider identification and card property information searches may be simultaneously performed by one searching process.

In addition, when the property change information is received from the change management unit 140, the database controlling unit 122 records changed property information in the table matched to the provider based on the card serial numbers and the property change information.

For example, when it is assumed that the card numbers are 4200 1243 5678 000 and the user information of the card is changed to “adult”, the first six numbers (420012) of the card are identification numbers of the card provider, and the remaining numbers (345678000) are serial numbers of the card. Therefore, the database controlling unit 122 searches the table 124a corresponding to the card provider identification numbers 420012, and records property change information (i.e., “adult”) in a record corresponding to the card serial numbers (345678000) among records of the searched table 124a.

In the above property information management method according to the exemplary embodiment of the present invention, since various pieces of property change information are stored and managed in a table, the information may be efficiently managed with a small memory area.

A method (S112) for generating the final card property information shown in FIG. 4 will be described with reference to FIG. 5 and FIG. 6.

FIG. 6 is a flowchart representing a method for processing the final card property information in the database management unit 120 according to the exemplary embodiment of the present invention.

The database controlling unit 122 determines in step S200 whether there is a table corresponding to the provider identification numbers, based on the card numbers of the card property information deciphered by the card identifying unit 110. In further detail, when it is assumed that the card serial numbers are 4200 1243 5678 000, the database controlling unit 122 refers to the first six numbers (420012) that are the provider identification numbers to determine in step S200 whether there is a table having a table name that is the same as the provider identification numbers (or a table matched to the provider identification numbers).

When it is determined in step S200 that there are the provider identification numbers, the database controlling unit 122 determines in step S202 whether the table corresponding to the provider identification numbers includes update information. In further detail, the database controlling unit 122 determines the card serial numbers from the remaining numbers of the card and determines whether the provider table includes property information corresponding to the card serial numbers to determine in step $202 whether there is the update information.

When it is determined in step S202 that the table corresponding to the provider identification numbers includes the update information, the database controlling unit 122 uses searched property change information as the final card property information in steps S204 and S206.

In addition, when it is determined in step S202 that the table corresponding to the provider identification numbers does not include the update information, the database controlling unit 122 determines that the card property information is not changed after the card is issued, and uses the existing card property information (i.e., the card property information obtained from the card identifying unit 110) as the final card property information in steps S206 and S208.

Subsequently, the authorization processing unit 130 uses the obtained final card property information and performs the above authorization process.

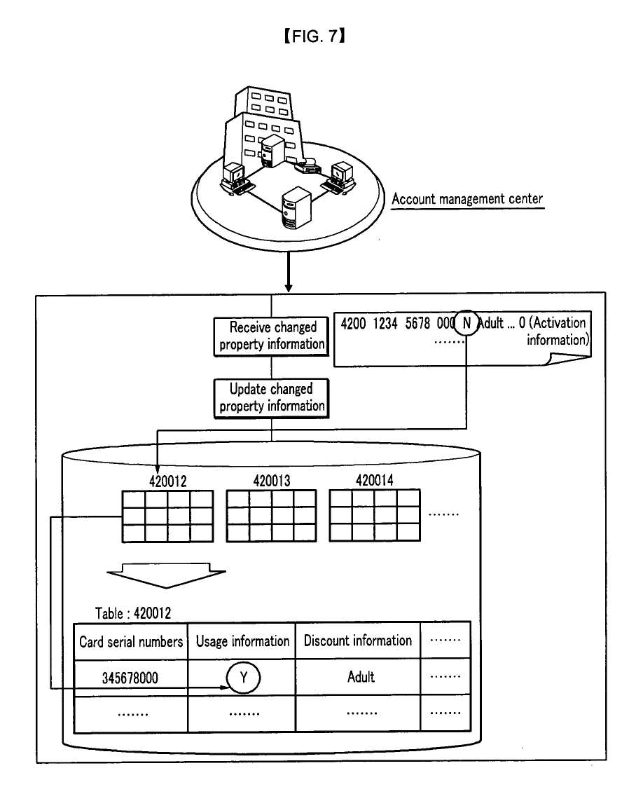

FIG. 7 is a diagram of a process for updating the property information in the database management system according to the exemplary embodiment of the present invention.

As shown in FIG. 7, the account management center system 300 collects property information that is cyclically transmitted from the card provider system 200, and transmits the card property change information to the respective card authorization terminal systems 100.

Thereby, the change management unit 140 of the card authorization terminal system 100 receives the card property change information of “4200 1243 5678 000 N adult . . . O” from the account management center system 300, and transmits the received card property change information to the database management unit 120. In this case, the card property change information of “4200 1243 5678 000 N adult . . . O” includes provider identification numbers (420012), card serial numbers (435678000), changed property information (N), and activation information (O). Here, the activation information (O) is property information that is changed to the same type as the property information of the card and is changed to the original property information.

The database controlling unit 122 stores the card property change information (4200 1243 5678 000 N adult . . . O) received from the change management unit 140 in the temporary property change information database 126, searches a predetermined table from the provider identification numbers (420012) of the card property change information (4200 1243 5678 000 N adult . . . O) stored in the temporary property change information database 126 at a predetermined time, searches a corresponding record from the card serial numbers, and updates the corresponding record based on the changed property information (N).

In FIG. 7, according to the exemplary embodiment of the present invention, since the changed property information (N) is property information (O) changed to the same type as the property information of the card, it is not required to modify the corresponding information in the table, and empty memory space may be optimized by deleting the record information corresponding to the card serial numbers 435678000. That is, according to the exemplary embodiment of the present invention, when the card property information is changed twice or more than twice and the card property information is changed to property information that is the same as the original card information, the property information is not managed and is deleted, and therefore the memory space may be optimized.

As described, according to the exemplary embodiment of the present invention, tables are generated in a database management system according to identification numbers for identifying the card provider, and serial numbers and property information of the card numbers including the changed properties are stored. In addition, it may be simultaneously determined through one piece of card property change information whether the card is valid and the property information is changed, and therefore the card authorization process may be quickly performed.

Further, according to the exemplary embodiment of the present invention, since new property information may be managed by adding one column to the table when the new property information is added to be managed, various pieces of property information may be added and managed in a relatively small memory space.

In addition, according to the exemplary embodiment of the present invention, since the database management unit 120 is realized as the DBMS, which is an exclusive process using a process that is different from the authorization process, malfunctions of some units may not affect other units, and therefore the card authorization terminal system may be stably managed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A card authorization terminal system comprising:
a card identifying unit for deciphering card property information stored in a card and determining whether the card is valid;
a database management unit for generating final card property information based on the card property information deciphered by the card identifying unit and property change information stored in the database management unit; and
an authorization processing unit for calculating charges and processing card transactions based on the final card property information generated by the database management unit.

2. The card authorization terminal system of claim 1, wherein the database management unit is realized as a database management system (DBMS) using an exclusive process that is different from those of the authorization processing unit and the card identifying unit.

3. The card authorization terminal system of claim 2, further comprising a change management unit for cyclically receiving new property change information and providing the property change information to the database management unit.

4. The card authorization terminal system of claim 3, wherein the database management unit comprises:
a master property change information database for storing changed card property information;
a temporary property change information database for temporarily storing the new property change information received from the change management unit; and
a database controlling unit for updating the master property change information database based on the new property change information stored in the temporary property change information database.

5. The card authorization terminal system of claim 4, wherein the master property change information database comprises a plurality of tables matched to card provider identification numbers, and each table stores card serial numbers and card property change information.

6. The card authorization terminal system of claim 4, wherein the database management unit comprises a plurality of tables matched to card provider identification numbers, and a record of each table stores card serial numbers and card property change information.

7. The card authorization terminal system of claim 6, wherein a name of each table is the same as the card provider identification numbers.

8. The card authorization terminal system of claim 3, wherein the new property change information has provider identification numbers, card serial numbers, and changed property information.

9. The card authorization terminal system of claim 8, wherein the new property change information has activation information that is property information changed to the same type as the property information of the card.

10. A card management method of a card authorization terminal system, the card management method comprising:
deciphering card property information written in a card;
searching property change information stored in a database management unit based on the card property information deciphered from the card, and generating final card property information; and
calculating charges by using the final card property information, and processing a card transaction list.

11. The card management method of claim 10, wherein searching property change information includes the stored property change information is generated as the final card property information when the database management unit stores the property change information, and the card property information deciphered in deciphering card property information written in a card is generated as the final card property information when the database management unit does not store the property change information.

12. The card management method of claim 10, wherein the database management unit is realized as a database management system using an exclusive process.

13. The card management method of claim 12, wherein the database management unit includes a plurality of tables matched to card provider identification numbers, and a record of each table stores card serial numbers and card property change information.

14. The card management method of claim 13, wherein searching property change information comprises:
determining whether there is a table corresponding to the provider identification numbers included in the card property information deciphered from the card;
determining whether the table corresponding to the provider identification numbers includes property change information when it is determined that there are the provider identification numbers; and
generating the property change information as the final card property information when the table includes the property change information, and generating the card property information deciphered in deciphering card property information written in a card as the final card property information when the table does not include the property change information.

15. The card management method of claim 14, further comprising:
externally receiving new property change information; and
updating the property change information stored in the database management unit based on the received new property change information.

16. The card management method of claim 15, wherein a name of each table is the same as the card provider identification numbers.

17. The card management method of claim 16, wherein the new property change information includes the provider identification numbers, the card serial numbers, the changed property information, and activation information that is property information changed to the same type as the property information of the card.

18. The card management method of claim 17, wherein updating the property change information includes, when the new property change information includes the activation information, property information corresponding to the card serial numbers is deleted.

19. The card authorization terminal system of claim 1, wherein the database management unit comprises a plurality of tables matched to card provider identification numbers, and a record of each table stores card serial numbers and card property change information.

20. The card management method of claim 13, further comprising:
externally receiving new property change information; and
updating the property change information stored in the database management unit based on the received new property change information.
